(19) United States
(12) Patent Application Publication
(10) Pub. No.: US 2009/0134370 A1
(43) Pub. Date: May 28, 2009

(54) CONDUCTIVE HALOGEN FREE FLAME RETARDANT THERMOPLASTIC COMPOSITION

(76) Inventors: Herve Cartier, Chantilly (FR); Alexis Chopin, Saint Maximin (FR)

Correspondence Address: SABIC - LNP-CE 08CE;SABIC Innovative Plastics - IP LEGAL, ONE PLASTICS AVENUE, PITTSFIELD, MA, 01201-3697, US

(21) Appl. No.: 12/173,055

(22) Filed: Jul. 15, 2008

Related U.S. Application Data
(60) Provisional application No. 60/950,894, filed on Jul. 20, 2007.

(51) Int. Cl. C09K 21/12

(52) U.S. Cl. 252/602

(57) ABSTRACT

A flame retardant thermoplastic composition having excellent conductivity and physical properties that includes a thermoplastic resin, a flame retardant including a metal salt of phosphinic acid, disphosphinic acid, or a combination thereof and optionally at least one nitrogen compound selected from benzoguanine, terepthalic ester of tris(hydroxyethyl)isocyanurate, allontoin, glucoluril, melamine cyanurate, melamine phosphate, dimelamine phosphate, melamine pyrophosphate, melam, melem, melon and a mixture including at least one of the foregoing nitrogen compounds, an electrically conductive filler, and a reinforcing agent; wherein a molded sample of the thermoplastic composition that has been electrostatically painted is capable of achieving ASTM D3359 GT0 or GT1. The compositions are useful in forming articles capable of performing as metal replacements and/or being electrostatically painted.

### CROSS REFERENCE TO RELATED APPLICATIONS

The present application claims priority to U.S. Provisional Patent Application No. 60/950,894 filed Jul. 20, 2007, which is hereby incorporated by reference in its entirety.

### FIELD OF THE INVENTION

The present invention relates to thermoplastic compositions, and in particular to thermoplastic compositions having improved conductivity and impact strength and/or rigidity. The present invention also relates to methods of manufacturing these compositions and articles that include these compositions.

### BACKGROUND OF THE INVENTION

Conductive polymers are finding wider use in a variety of applications. These polymers have found use in applications ranging from automotive parts to electronic appliances, building and construction. Because of their broad use, particularly in automotive applications, it is desirable to provide polymer compounds that can be painted, thereby enabling the look and appearance of a metallic part to be achieved using a plastic substrate.

One such polymer used in these applications includes conductive polyamide compositions. Conductive polyamide compositions are commonly used for electrostatic painting. These formulations generally contain conductive fillers in an amount of 1 to 15% to bring surface resistivity (as measured by ISO 60093) in the range of 1-10⁴ Ohm/square meter. Due to the conductivity of the composition, these compositions are capable of being electrostatically painted.

In such a painting process, the coating is typically applied electrostatically and is then cured under heat to allow it to flow and form a film. Typical curing temperatures are around 200° C. and generally require a composition with a good thermal resistance (i.e. the compositions have a Heat Distortion Temperature (HDT), as measured by ISO 75, of 200° C. or greater). In addition, one of the most critical requirements is a good adhesion of the paint layer on the plastic item. This can be evaluated using the cross-hatch adhesion test method (ASTM 3359/ISO 2409) where a GT0 rating is considered the best. However, current conductive polyamide compositions are often unable to provide adhesion capabilities that enable these materials to achieve GT0 ratings.

In addition, these conductive polyamide compositions, when used in automotive applications, are beneficially used as replacements for metal parts, thereby making the auto lighter and more fuel efficient. However, when used as a metal replacement, for structural application, a high rigidity is often needed (typically flexural modulus >14 GPa, as measured by ISO 178) as well as good flame retardant properties passing at least Glow Wire Flammability Index at 960° C./1.6 mm (GWFI as measured using IEC 695-2-1) and a UL-94 V0 vertical burning test rating at 1.6 mm (as measured according to UL-94). Nevertheless, the current conductive polyamide compositions are oftentimes unable to provide a beneficial rigidity as well as a beneficial flame retardancy as the flame retardants used in many prior art conductive polyamide compositions oftentimes adversely affect the impact strength and/or rigidity of the conductive polyamide composition.

Accordingly, it would be beneficial to provide a thermoplastic material that offers improved conductivity such that these thermoplastic materials may have greater utility in applications as a metal replacement. It would also be beneficial to provide a thermoplastic material that offers improved conductivity to enable an article made with the thermoplastic material to be electrostatically painted. It would also be beneficial to provide a thermoplastic material that offers improved heat resistance to enable an article made with the thermoplastic material to be electrostatically painted and then cured using a heat treatment process without adversely affecting the impact strength and/or rigidity of the composition.

### BRIEF SUMMARY OF THE INVENTION

The present invention provides a flame retardant thermoplastic composition having improved conductivity while offering excellent physical properties in the areas of stiffness and/or rigidity. As such, the compositions may be used to form articles that are capable of being used as metal replacements in a variety of applications. In addition, due to the conductivity of the compositions, articles made therefrom are capable of being electrostatically painted while offering heat resistant characteristics that enable the article to withstand the curing temperatures used for electrostatic parts. The compositions of the present invention can be used in a variety of applications, such as electronic and automotive applications, building and construction industry, as a metal replacement material, thereby making the resulting article lighter while also maintaining and/or improving the characteristics of the article.

Accordingly, in one aspect, the present invention provides a thermoplastic composition having a thermoplastic resin, a flame retardant including a metal salt of phosphinic acid, disphosphinic acid, or a combination thereof, an electrically conductive filler, and a reinforcing agent; wherein a molded sample of the thermoplastic composition is capable of being electrostatically painted.

In another aspect, the present invention provides a method of forming a thermoplastic composition including the steps of blending a thermoplastic resin; a flame retardant including a metal salt of phosphinic acid, disphosphinic acid, or a combination thereof, an electrically conductive filler; and a reinforcing agent; and extruding the thermoplastic composition; wherein a molded sample of the thermoplastic composition is capable of being electrostatically painted.

In yet another aspect, the present invention provides an article of manufacture that includes a composition having a thermoplastic resin, a flame retardant including a metal salt of phosphinic acid, disphosphinic acid, or a combination thereof, an electrically conductive filler, and a reinforcing agent; wherein a molded sample of the thermoplastic composition is capable of being electrostatically painted.

### DETAILED DESCRIPTION OF THE INVENTION

The present invention is more particularly described in the following description and examples that are intended to be illustrative only since numerous modifications and variations therein will be apparent to those skilled in the art. As used in the specification and in the claims, the term “comprising” may include the embodiments “consisting of” and “consisting essentially of.” All ranges disclosed herein are inclusive of the endpoints and are independently combinable. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value.

The present invention relates to a thermoplastic composition that is electrically conductive and halogen-free flame retardant while offering high stiffness and/or rigidity. Due to its unique property combination, the compositions of the present invention are capable of being used as a metal replacement in a variety of different applications. In additional embodiments of the present invention, the compositions are capable of being injection molded into structural parts that can be electrostatic painted. Injection molded parts of the composition exhibit sufficient conductivity for electrostatic painting, an excellent adhesion of the paint and suitable heat resistance to withstand curing treatment of the painting process. Painted parts using the compositions of the present invention offer excellent surface appearance that is nearly identical to painted metal parts. These compositions can be used in a variety of electronic, appliance, building construction and automotive applications. In additional embodiments of the present invention, the compositions are capable of being extruded into profiles, pipes, plaques, sheets, and the like.

The compositions of the present invention include a thermoplastic resin, a non-halogen flame retardant, an electrically conductive filler, and a reinforcing agent. It has been found that the addition of the non-halogen flame retardant to the electrically conductive thermoplastic composition acts as a synergistic additive in enhancing the adhesion of an electrostatic paint coating to the thermoplastic composition. As such, the resulting compositions can be used in articles to provide an article having excellent electrostatic painting behavior, mechanical properties, heat properties and/or flammability.

Accordingly, in one aspect, the thermoplastic compositions of the present invention include a thermoplastic resin that includes an organic polymer. The thermoplastic resin is selected as the base material for the composition. Examples of thermoplastic resins that may be used in the present invention include, but are not limited to, polyamide resin, polyester resin, aromatic polyamide resin, and combinations including at least one of the foregoing resins. Specific examples of thermoplastic resins that may be used in the present invention include, but are not limited to nylon 6, nylon 6,6, nylon 6,10, nylon 6,12, nylon 12, nylon 4,6, a copolymer of nylon 6,6 and nylon 6, polybutylene terephthalate (PBT), polyethylene terephthalate (PET), and combinations including at least one of the foregoing resins.

Accordingly, in one embodiment, polyamides, including aromatic polyamides, may be used as the thermoplastic material in the conductive composition. Polyamides are generally derived from the polymerization of organic lactams having from 4 to 12 carbon atoms. Beneficial lactams are represented by the formula (IX)

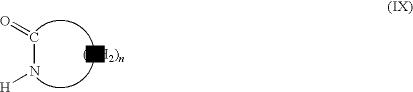

wherein n is about 3 to about 11. In one embodiment, the lactam is epsilon-caprolactam having n equal to 5.

Polyamides may also be synthesized from amino acids having from 4 to 12 carbon atoms. Beneficial amino acids are represented by the formula (X)

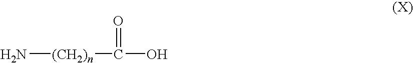

wherein n is about 3 to about 11. In one embodiment, the amino acid is epsilon-aminocaproic acid with n equal to 5.

Polyamides may also be polymerized from aliphatic dicarboxylic acids having from 4 to 12 carbon atoms and aliphatic diamines having from 2 to 12 carbon atoms. Beneficial aliphatic diamines are represented by the formula (XI)

H₂N—(CH₂)ₙ—NH₂ (XI)

wherein n is 2 to 12. A highly beneficial aliphatic diamine is hexamethylenediamine (H₂N(CH₂)₆NH₂). In one embodiment, the molar ratio of the dicarboxylic acid to the diamine be 0.66 to 1.5. Within this range it is generally beneficial to have the molar ratio be greater than or equal to 0.81, beneficially greater than or equal to 0.96. Also beneficial within this range is an amount of less than or equal to 1.22, beneficially less than or equal to 1.04. Beneficial polyamides include nylon 6, nylon 6,6, nylon 4,6, nylon 6, 12, nylon 10, or the like, or combinations including at least one of the foregoing nylons.

For the synthesis of polyamides from lactams, suitable catalysts include water and the omega-amino acids corresponding to the ring-opened (hydrolyzed) lactam used in the synthesis. Other suitable catalysts include metallic aluminum alkylates (MAl(OR)₃H; wherein M is an alkali metal or alkaline earth metal, and R is C₁-C₁₂ alkyl), sodium dihydrobis(2-methoxyethoxy)aluminate, lithium dihydrobis(tert-butoxy)aluminate, aluminum alkylates (Al(OR)₂R; wherein R is C₁-C₁₂ alkyl), N-sodium caprolactam, magnesium chloride or bromide salt of epsilon-caprolactam (MgXC₆H₁₀NO, X═Br or Cl), dialkoxy aluminum hydride. Suitable initiators include isophthaloybiscaprolactam, N-acetalcaprolactam, isocyanate epsilon-caprolactam adducts, alcohols (ROH; wherein R is C₁-C₁₂ alkyl), diols (HO—R—OH; wherein R is R is C₁-C₁₂ alkylene), omega-aminocaproic acids, and sodium methoxide.

In another embodiment, polyesters may be used as the thermoplastic material in the conductive composition. The polyesters used in the practice of the present invention include polymeric glycol esters of terephthalic acid and isophthalic acid. They are widely available commercially. Otherwise they can be readily prepared by known techniques, such as by the alcoholysis of esters of terephthalic and/or isophthalic acid with a glycol and subsequent polymerization, by heating glycols with free acids or with halide derivatives thereof, and similar processes.

Although the glycol portion of the polyester can contain from 2 to 10 atoms, in an alternative embodiment, the glycol portion of the polyester can contain from 2 to 4 carbon atoms in the form of linear methylene chains.

Beneficial polyesters will be of the family consisting of high molecular weight polymeric glycol terephthalates or isophthalates having repeating units of the general formula (XII)

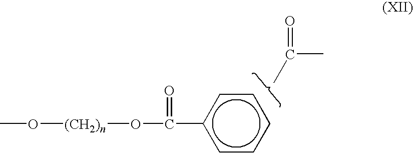

wherein n is a whole number of from 2 to 4, and mixtures of such esters, including copolyesters of terephthalic and isophthalic acids of up to 30 mole percent isophthalic units.

Especially preferred polyesters are poly(ethylene terephthalate) and poly(1,4-butylene terephthalate). Special mention is made of the latter because it crystallizes at such a good rate that it may be used for injection molding without the need for nucleating agents or long cycles, as is sometimes necessary with poly(ethylene terephthalate).

Illustratively, high molecular weight polyesters, such as poly(1,4-butylene terephthalate), will have an intrinsic viscosity of at least about 0.7 deciliters/gram and, preferably, at least 0.8 deciliters/gram as measured in a 60:40 phenol tetrachloroethane mixture at 30.degree. C. At intrinsic viscosities of at least about 1.0 deciliters/gram, there is further enhancement of toughness of the present compositions.

The copolyesters useful for the present compositions are preferably prepared from terephthalic acid, isophthalic acid, or reactive derivatives thereof, or any combination of the foregoing, and a glycol, which may be a straight or branched chain aliphatic and/or cycloaliphatic glycol. Illustratively, the glycol will be ethylene glycol; 1,4-butanediol; 1,5-pentanediol; 1,6-hexanediol; 1,9-nonanediol; 1,10-decanediol; neopentyl glycols; 1,4-cyclohexanediol; 1,4-cyclohexane dimethanol; a mixture of any of the foregoing, or the like. Additionally, other dicarboxylic acids useful for the acid component of the copolyesters include, without limitation, aromatic dicarboxylic acids such as napthalene dicarboxylic acid, and compounds of the formula (XIII)

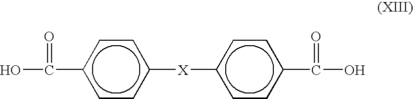

in which X may be alkylene or alkylidene of from 1 to 4 carbon atoms, carbonyl, sulfonyl, oxygen or a bond between the benzene rings, and the like, and aliphatic dicarboxylic acids having from 6 to 12 carbon atoms in the chain including suberic acid, sebacic acid, azelaic acid, adipic acid and the like.

The foregoing copolyesters may be prepared by ester interchange in accordance with standard procedures. These copolyesters are, in one embodiment, derived from at least 50% poly(1,4-butylene terephthalate) units.

Also useful for the compositions of the present invention are block copolyesters derived from blocks of (i) terminally-reactive poly(1,4-butylene terephthalate), preferably of low molecular weight, and (ii) terminally-reactive copolyesters, as described above, or (iii) a terminally-reactive aliphatic polyester, or any combination thereof. The terminal groups can include hydroxyl, carboxyl, carboalkoxy, and the like, including reactive derivatives thereof.

Generally, these block copolyesters may be prepared by reacting the aforementioned terminally-reactive units in the presence of a catalyst for transesterification, such as zinc acetate, manganese acetate, titanium esters and the like. After initial mixing polymerization is carried out under standard conditions, e.g., 220 to 280° C., in a high vacuum e.g., 0.1 to 2 mm Hg, to form the block copolymer of minimum randomization in terms of distribution of chain segments.

In one embodiment, the copolyester units (ii) are derived from an aliphatic glycol and a mixture of aromatic and aliphatic dibasic acids in which the mole ratio concentration of aromatic to aliphatic acids is from 1 to 9 to about 9 to 1, with an especially preferred range being from about 3 to 7 to about 7 to 3.

Further, the terminally-reactive aliphatic polyester units (iii) will contain substantially stoichiometric amounts of the aliphatic diol and the aliphatic dicarboxylic acid, although hydroxy-containing terminal groups are useful in select embodiments.

In general, the block copolyesters useful for the invention preferably include from 95 to 50 parts by weight of segments of poly(1,4-butylene terephthalate). Those poly(1,4-butylene terephthalate) blocks, before incorporation into the block copolyester, will preferably have an intrinsic viscosity of above 0.1 dl/g. and more preferably, between 0.1 to 0.5 dl/g., as measured in a 60:40 mixture of phenol tetrachlorethane at 30.degree. C. The balance, 50 to 5 parts by weight of the block copolyester will include blocks of copolyester (ii) and aliphatic polyester (iii) above.

As will be understood by those skilled in the art, the poly(1,4-butylene terephthalate) block can be straight chain or branched, e.g., by use of a branching component which contains at least 3 ester-forming groups. This can be a polyol, e.g., pentaerythritol, trimethylolpropane, and the like, or a polybasic acid compound, e.g., trimethyl trimesitate, and the like.

The amount of the thermoplastic resin added to the thermoplastic compositions of the present invention may be based on the selected properties of the thermoplastic compositions as well as molded articles made from these compositions. Other factors include the amount and/or type of flame retardant used, the amount and/or type of flame retardant used, the amount and/or type of reinforcing agent used, the amount and/or type of conductive filler used, and/or the amount and presence of other components in the thermoplastic compositions. In one embodiment, the thermoplastic resin is present in amounts of from 30 to 90 wt. %. In another embodiment, the thermoplastic resin is present in amounts from 50 to 90 wt. %. In still another embodiment, the thermoplastic resin is present in amounts from 60 to 80 wt. %.

In addition to the thermoplastic resin, the conductive compositions of the present invention also include a non-halogen flame retardant material that contains a metal phosphinate in combination with a nitrogen compound to provide an excellent flame retardancy of the composition. As discussed, the flame retardant provides flame retardant characteristics to the compositions of the present invention as well as any articles made using these compositions. As such, the thermoplastic compositions are of particular utility in the manufacture of flame retardant articles that pass the UL94 vertical burn tests, in particular the UL94 V0 standard, which is more stringent than the UL94 V1 standard. Thin articles present a particular challenge in the UL 94 tests, because compositions suitable for the manufacture of thin articles tend to have a higher flow.

Flame retardance of samples made from the thermoplastic compositions of the present invention is excellent. Using this standard, the thermoplastic compositions are formed into a molded article having a given thickness. In one embodiment, a molded sample of the thermoplastic composition is capable of achieving UL94 V0 or V1 rating at a thickness of 1.5 mm (+10%). In another embodiment, a molded sample of the thermoplastic composition is capable of achieving UL94 V0 or V1 rating at a thickness of 1.2 mm (+10%). In still another embodiment, a molded sample of the thermoplastic composition is capable of achieving UL94 V0 or V1 rating at a thickness of 1.0 mm (±10%). In yet another embodiment, a molded sample of the thermoplastic composition is capable of achieving UL94 V0 or V1 rating at a thickness of 0.8 mm (±10%). In still another embodiment, a molded sample of the thermoplastic composition is capable of achieving UL94 V0 or V1 rating at a thickness of 0.4 mm (±10%).

In addition, it has been found that the flame retardant also acts as an adhesion promoter to articles made from the compositions such that the paint applied to the articles is not easily worn away. As such, the thermoplastic compositions are of particular utility in the manufacture of articles that pass the cross-hatch adhesion test method (ASTM 3359/ISO 2409) where a GT0 rating is considered the best. In one embodiment, a molded sample of the thermoplastic composition is capable of achieving ASTM 3359 GT1 rating. In another embodiment, a molded sample of the thermoplastic composition is capable of achieving ASTM 3359 GT0 rating. In another embodiment, an extruded sample of the thermoplastic composition is capable of achieving ASTM 3359 GT0 rating.

In select embodiments of the present invention, the flame retardant contains a metal salt of phosphinic acid and/or disphosphinic acid and, optionally, at least one nitrogen compound selected from benzoguanine, terepthalic ester of tris(hydroxyethyl)isocyanurate, allontoin, glucoluril, melamine cyanurate, melamine phosphate, dimelamine phosphate, melamine pyrophosphate, melam, melem, melon and a mixture including at least one of the foregoing nitrogen compounds.

In specific embodiments of the present invention, the flame retardant includes, but is not limited to, a phosphinate of the formula (I) and/or a diphosphinate of the formula (II) and/or polymers of these, and their mixture thereof

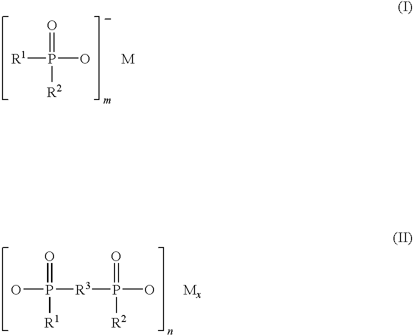

In which
R¹, R² is hydrogen, a linear or branched C1-C6 alkyl radical, and/or aryl radical;
R³ is a linear or branched C1-C10 alkylene, arylene, alkylarylene, or arylalkylene radical;
M is Calcium, Aluminium and/or Zinc
m is 1, 2 or 3;
n is 1 or 3
x is 1 or 2.
   Exemplary flame retardants include Exolit OP1230 by Clariant, a nitrogen compound including condensation products of melamine and/or reaction products of condensation products of melamine with phosphoric acid and/or mixture of these, such as melem, melom, melamine cyanurate, melamine phosphate, dimelamine phosphate and/or melamine pyrophosphate, melamine polyphosphate, benzoguanine, terepthalic ester of tris(hydroxyethyl)isocyanurate, allontoin, glucoluril.

“Phosphinic salt” or “phosphinate” as used herein includes salts of phosphinic and diphosphinic acids and polymers thereof. Exemplary phosphinic acids as a constituent of the phosphinic salts include dimethylphosphinic acid, ethylmethylphosphinic acid, diethylphosphinic acid, methyl-n-propylphosphinic acid, methanedi(methylphosphinic acid), benzene-1,4-(dimethylphosphinic acid), methylphenylphosphinic acid and diphenylphosphinic acid. The salts of the phosphinic acids of the invention can be prepared by known methods that are described in U.S. Pat. Nos. 5,780,534 and 6,013,707 to Kleiner et al.

Exemplary phosphinate metal salts and/or diphosphinate metal salts include aluminum salt of dimethylphosphinic acid, aluminum salt of methylethylphosphinic acid, aluminum salt of methylpropylphosphinic acid, and the like.

The phosphinate and/or diphosphinate can be used alone or, in alternative embodiments, can include at least one nitrogen compound selected from the group consisting of condensation products of melamine and/or reaction products of condensation products of melamine with phosphoric acid, and/or mixtures thereof, including for example melam, melem, melon, melamine, melamine cyanurate, melamine phosphate compounds, dimelamine phosphate and/or melamine pyrophosphate, melamine polyphosphate compounds, benzoguanamine compounds, terepthalic ester compounds of tris(hydroxyethyl)isocyanurate, allantoin compounds, glycoluril compounds, ammeline, ammelide, and combinations thereof.

Suitable nitrogen compounds include those of the formula (III) to (VIII) or combinations thereof

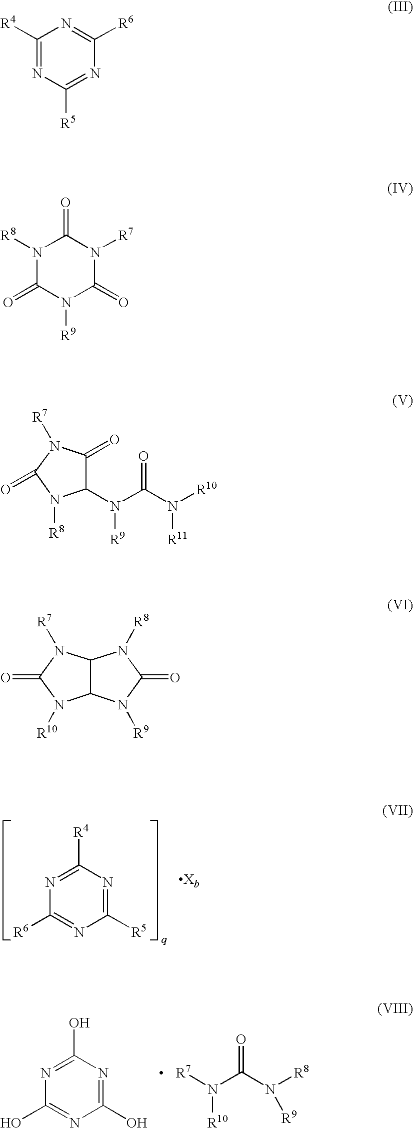

wherein R⁴, R⁵, and R⁶ are independently hydrogen, hydroxy, amino, or mono- or diC₁-C₈alkyl amino; or C₁-C₈alkyl, C₅-C₁₆cycloalkyl, -alkylcycloalkyl, wherein each may be substituted by a hydroxyl or a C₁-C₄hydroxyalkyl, C₂-C₈alkenyl, C₁-C₈alkoxy, -acyl, -acyloxy, C₆-C₁₂aryl, —OR¹² and —N(R¹²)R¹³ wherein R¹² and R¹³ are each independently hydrogen, C₁-C₈alkyl, C₅-C₁₆cycloalkyl, or -alkylcycloalkyl; or are N-alicyclic or N-aromatic, where N-alicyclic denotes cyclic nitrogen containing compounds; R⁷, R⁸, R⁹, R¹⁰ and R¹¹ are independently hydrogen, C₁-C₈alkyl, C₅-C₁₆cycloalkyl or -alkylcycloalkyl, each may be substituted by a hydroxyl or a C₁-C₄hydroxyalkyl, C₂-C₈alkenyl, C₁-C₈alkoxy, -acyl, -acyloxy, C₆-C₁₂aryl, and —O—R¹²; X is phosphoric acid, pyrophosphoric acid; q is 1, 2, 3, or 4; and b is 1, 2, 3, or 4.

Exemplary nitrogen compounds include allantoin, benzoguanaine, glycoluril, melamine, melamine cyanurate, melamine phosphate, melamine pyrophosphate, melamine polyphosphate, urea cyanurate, and the like.

The amount of the flame retardant added to the thermoplastic compositions of the present invention may be based on the selected properties of the thermoplastic compositions as well as molded articles made from these compositions. Other factors include the amount and/or type of thermoplastic resin used, the amount and/or type of flame retardant used, the amount and/or type of reinforcing agent used, the amount and/or type of conductive filler used, and/or the amount and presence of other components in the thermoplastic compositions. In one embodiment, the flame retardant is present in amounts of from 3 to 30 wt. %. In another embodiment, the flame retardant is present in amounts from 10 to 25 wt. %. In still another embodiment, the flame retardant is present in amounts from 15 to 20 wt. %

In addition to the thermoplastic resin and the flame retardant, the thermoplastic compositions of the present invention include at least one conductive filler. The conductive filler is chosen such that the resulting thermoplastic composition is capable of being electrostatically painted. In one embodiment, the conductive filler is a carbon fiber. In another embodiment, the conductive filler is a metal fiber. In yet another embodiment, the conductive filler includes a mixture of carbon fibers and metal fibers. In still another embodiment, the conductive filler includes carbon black and a mixture alone or in combination with other conductive fillers. The conductive fillers are selected such that, in one embodiment, the thermoplastic compositions of the present invention have a surface resistivity of 1 to 10⁴ Ohm/square meter.

In an alternative embodiment, either alone or in conjunction with the carbon fibers and/or metal fibers, the conductive filler may include carbon nanotubes. In one embodiment, the carbon nanotubes are single-wall nanotubes while in an alternative embodiment; the carbon nanotubes are multi-wall nanotubes. Other conductive fillers that may be used in the present invention include, but are not limited to, carbon fibrils, metal coated mineral particles, small metal particles, vapor grown carbon tubes, and/or any other conductive filler that permits the resulting thermoplastic composition to be capable of being electrostatically painted.

The amount of conductive filler used in the thermoplastic composition is dependent on one more factors including, but not limited to, the thermoplastic resin used, the type of flame retardant used, the type of reinforcing agent used, and/or the presence of any other additives or fillers. In one embodiment, the amount of conductive filler added is from 0.5 to 40% by weight of the thermoplastic composition. In another embodiment, the amount of conductive filler added is from 1 to 35% by weight of the thermoplastic composition. In still another embodiment, the amount of conductive filler added is from 2 to 30% by weight of the thermoplastic composition.

Lastly, the compositions of the present invention include a reinforcing agent. Suitable fillers or reinforcing agents include, for example, fibers, such as asbestos, carbon fibers, or the like; silicates and silica powders, such as aluminum silicate (mullite), synthetic calcium silicate, zirconium silicate, fused silica, crystalline silica graphite, natural silica sand, or the like; boron powders such as boron-nitride powder, boron-silicate powders, or the like; alumina; magnesium oxide (magnesia); calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin including various coatings known in the art to facilitate compatibility with the polymeric matrix resin, or the like; single crystal fibers or “whiskers” such as silicon carbide, alumina, boron carbide, iron, nickel, copper, or the like; glass fibers, (including continuous and chopped fibers), such as E, A, C, ECR, R, S, D, and NE glasses and quartz, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends including at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations including at least one of the foregoing fillers or reinforcing agents.

The fillers and reinforcing agents may be coated with a layer of metallic material to facilitate conductivity, or surface treated with silanes to improve adhesion and dispersion with the polymeric matrix resin. In addition, the reinforcing fillers may be provided in the form of monofilament or multifilament fibers and may be used either alone or in combination with other types of fiber, through, for example, co-weaving or core/sheath, side-by-side, orange-type or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous fillers may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids.

The amount of reinforcing agent used in the thermoplastic composition is dependent on one more factors including, but not limited to, the thermoplastic resin used, the type of flame retardant used, the type of conductive filler used, and/or the presence of any other additives or fillers. In one embodiment, the amount of reinforcing agent added is from 0.5 to 45% by weight of the thermoplastic composition. In another embodiment, the amount of reinforcing agent added is from 1 to 40% by weight of the thermoplastic composition. In still another embodiment, the amount of reinforcing agent added is from 2 to 30% by weight of the thermoplastic composition.

The thermoplastic compositions of the present invention are essentially free of chlorine and bromine, particularly chlorine and bromine flame-retardants. “Essentially free of chlorine and bromine” as used herein refers to materials produced without the intentional addition of chlorine, bromine, and/or chlorine or bromine containing materials. It is understood however that in facilities that process multiple products a certain amount of cross contamination can occur resulting in bromine and/or chlorine levels typically on the parts per million by weight scale. With this understanding it can be readily appreciated that essentially free of bromine and chlorine may be defined as having a bromine and/or chlorine content of less than or equal to 100 parts per million by weight (ppm), less than or equal to 75 ppm, or less than or equal to 50 ppm. When this definition is applied to the fire retardant it is based on the total weight of the fire retardant. When this definition is applied to the thermoplastic composition it is based on the total weight of thermoplastic resin, electrically conductive filler, flame retardant, and reinforcing agent.

The thermoplastic compositions of the present invention offer improved adhesion of paint to a molded article made that includes the thermoplastic compositions. In addition, the thermoplastic compositions also offer one or more advantages relating to the physical properties of the composition. For example, in one embodiment, the thermoplastic compositions may further have a heat deflection temperature (HDT) of 150° C. or higher as measured by ISO 75. In another embodiment, the thermoplastic compositions may further have a HDT of 200° C. or higher as measured by ISO 75.

The thermoplastic compositions may further have tensile properties, such as Tensile Modulus that are improved. In one embodiment, the thermoplastic compositions have a Tensile Modulus of 5000 MPa or greater. In still another embodiment, the thermoplastic compositions have a Tensile Modulus of 10 GPa or greater.

In addition to the thermoplastic resin, flame retardant, conductive filler and reinforcing agent, the thermoplastic compositions of the present invention may include various additives ordinarily incorporated in resin compositions of this type. Mixtures of additives may be used. Such additives may be mixed at a suitable time during the mixing of the components for forming the composition. The one or more additives are included in the thermoplastic compositions to impart one or more selected characteristics to the thermoplastic compositions and any molded article made therefrom. Examples of additives that may be included in the present invention include, but are not limited to, heat stabilizers, process stabilizers, antioxidants, light stabilizers, plasticizers, antistatic agents, mold releasing agents, UV absorbers, lubricants, pigments, dyes, colorants, flow promoters or a combination of one or more of the foregoing additives.

Suitable heat stabilizers include, for example, organo phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers are generally used in amounts of from 0.01 to 0.5 parts by weight based on 100 parts by weight of the total composition, excluding any filler.

Suitable antioxidants include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants are generally used in amounts of from 0.01 to 0.5 parts by weight, based on 100 parts by weight of the total composition, excluding any filler.

Suitable light stabilizers include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers are generally used in amounts of from 0.1 to 1.0 parts by weight, based on 100 parts by weight of the total composition, excluding any filler.

Suitable plasticizers include, for example, phthalic acid esters such as dioctyl-4,5-epoxy-hexahydrophthalate, tris-(octoxycarbonylethyl)isocyanurate, tristearin, epoxidized soybean oil or the like, or combinations including at least one of the foregoing plasticizers. Plasticizers are generally used in amounts of from 0.5 to 3.0 parts by weight, based on 100 parts by weight of the total composition, excluding any filler.

Suitable antistatic agents include, for example, glycerol monostearate, sodium stearyl sulfonate, sodium dodecylbenzenesulfonate or the like, or combinations of the foregoing antistatic agents. In one embodiment, carbon fibers, carbon nanofibers, carbon nanotubes, carbon black, or any combination of the foregoing may be used in a polymeric resin containing chemical antistatic agents to render the composition electrostatically dissipative.

Suitable mold releasing agents include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of from 0.1 to 1.0 parts by weight, based on 100 parts by weight of the total composition, excluding any filler.

Suitable UV absorbers include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene)bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight based on 100 parts by weight of the total composition, excluding any filler.

Suitable lubricants include for example, fatty acid esters such as alkyl stearyl esters, e.g., methyl stearate or the like; mixtures of methyl stearate and hydrophilic and hydrophobic surfactants including polyethylene glycol polymers, polypropylene glycol polymers, and copolymers thereof e.g., methyl stearate and polyethylene-polypropylene glycol copolymers in a suitable solvent; or combinations including at least one of the foregoing lubricants. Lubricants are generally used in amounts of from 0.1 to 5 parts by weight, based on 100 parts by weight of the total composition, excluding any filler.

Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates; sulfates and chromates; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations including at least one of the foregoing pigments. Pigments are generally used in amounts of from 1 to 10 parts by weight, based on 100 parts by weight based on 100 parts by weight of the total composition, excluding any filler.

Suitable dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (preferably oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti-stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 3-(2′-benzimidazolyl)-7-N,N-diethylaminocoumarin; 3-(2′-benzothiazolyl)-7-diethylaminocoumarin; 2-(4-biphenylyl)-5-(4-t-butylphenyl)-1,3,4-oxadiazole; 2-(4-biphenyl)-6-phenylbenzoxazole-1,3; 2,5-Bis-(4-biphenylyl)-1,3,4-oxadiazole; 2,5-bis-(4-biphenylyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-diethylamino-4-methylcoumarin; 7-diethylamino-4-trifluoromethylcoumarin; 2,2′-dimethyl-p-quaterphenyl; 2,2-dimethyl-p-terphenyl; 7-ethylamino-6-methyl-4-trifluoromethylcoumarin; 7-ethylamino-4-trifluoromethylcoumarin; nile red; rhodamine 700; oxazine 750; rhodamine 800; IR 125; IR 144; IR 140; IR 132; IR 26; IR5; diphenylhexatriene; diphenylbutadiene; tetraphenylbutadiene; naphthalene; anthracene; 9,10-diphenylanthracene; pyrene; chrysene; rubrene; coronene; phenanthrene or the like, or combinations including at least one of the foregoing dyes. Dyes are generally used in amounts of from 0.1 to 5 parts by weight, based on 100 parts by weight of the total composition, excluding any filler.

Suitable colorants include, for example titanium dioxide, anthraquinones, perylenes, perinones, indanthrones, quinacridones, xanthenes, oxazines, oxazolines, thioxanthenes, indigoids, thioindigoids, naphthalimides, cyanines, xanthenes, methines, lactones, coumarins, bis-benzoxazolylthiophene (BBOT), napthalenetetracarboxylic derivatives, monoazo and disazo pigments, triarylmethanes, aminoketones, bis(styryl)biphenyl derivatives, and the like, as well as combinations including at least one of the foregoing colorants. Colorants are generally used in amounts of from 0.1 to 5 parts by weight, based on 100 parts by weight of the total composition, excluding any filler.

Suitable blowing agents include for example, low boiling halohydrocarbons and those that generate carbon dioxide; blowing agents that are solid at room temperature and when heated to temperatures higher than their decomposition temperature, generate gases such as nitrogen, carbon dioxide, ammonia gas, such as azodicarbonamide, metal salts of azodicarbonamide, 4,4′ oxybis(benzenesulfonylhydrazide), sodium bicarbonate, ammonium carbonate, or the like, or combinations including at least one of the foregoing blowing agents. Blowing agents are generally used in amounts of from 1 to 20 parts by weight, based on 100 parts by weight of the total composition, excluding any filler.

Additionally, materials to improve flow and other properties may be added to the composition, such as low molecular weight hydrocarbon resins. Particularly useful classes of low molecular weight hydrocarbon resins are those derived from petroleum C₅ to C₉ feedstock that are derived from unsaturated C₅ to C₉ monomers obtained from petroleum cracking. Non-limiting examples include olefins, e.g. pentenes, hexenes, heptenes and the like; diolefins, e.g. pentadienes, hexadienes and the like; cyclic olefins and diolefins, e.g. cyclopentene, cyclopentadiene, cyclohexene, cyclohexadiene, methyl cyclopentadiene and the like; cyclic diolefin dienes, e.g., dicyclopentadiene, methylcyclopentadiene dimer and the like; and aromatic hydrocarbons, e.g. vinyltoluenes, indenes, methylindenes and the like. The resins can additionally be partially or fully hydrogenated.

The thermoplastic compositions of the present invention may be formed using any known method of dispersing one or more fillers in a thermoplastic resin. In one embodiment, the thermoplastic resin has a sufficient molecular weight to enable the fillers to be dispersed in the thermoplastic resin using an extrusion process. When an extrusion process is used, it has been discovered that higher process speeds provide generally better dispersion of the fillers in the thermoplastic resin.

In one embodiment, the flame retardant, thermoplastic resin, reinforcing agent and conductive filler, and/or other optional components are first blended in a high speed mixer. Other low shear processes including but not limited to hand mixing may also accomplish this blending. The blend is then fed into the throat of a twin-screw extruder via a hopper. Alternatively, one or more of the components may be incorporated into the composition by feeding directly into the extruder at the throat and/or downstream through a sidestuffer. Such additives may also be compounded into a masterbatch with a desired polymeric resin and fed into the extruder. The extruder is generally operated at a temperature higher than that necessary to cause the composition to flow. The extrudate is immediately quenched in a water batch and pelletized. The pellets so prepared when cutting the extrudate may be one-fourth inch long or less as desired. Such pellets may be used for subsequent molding, shaping, or forming.

Shaped, formed, or molded articles including the thermoplastic compositions are also provided. The thermoplastic compositions can be molded into useful shaped articles by a variety of means such as injection molding, extrusion, rotational molding, blow molding and thermoforming to form articles. Due to the ability of the articles to be electrostatically painted as well as providing excellent physical properties, the articles are especially useful as metal replacements in a variety of electronic and automotive applications, as well as other applications.

Examples of articles that may be made using the compositions of the present invention include, but are not limited to, automotive body panels, computer and business machine housings such as housings for monitors, hand held electronic device housings such as housings for cell phones, electrical connectors, and components of lighting fixtures, ornaments, home appliances, roofs, greenhouses, sun rooms, swimming pool enclosures, safety door locking systems, heat systems and radiators, shutters, accessories for fences and posts, and the like. The above-described compositions are of particular utility in the manufacture of articles including a minimum wall thickness of as low as 0.1 mm, 0.5 mm, 1.0 mm, or 2.0 mm (each ±10%), although with thinner walls, flame retardancy may be affected. The above-described compositions are also of particular utility in the manufacture of articles including a minimum wall thickness of 2.25 to 2.90 mm (each ±10%), in an alternative embodiment 2.4 to 2.75 mm (each ±10%), and in another embodiment, 2.40 to 2.60 mm (each ±10%). Minimum wall thicknesses of 2.25 to 2.50 mm (each ±10%) may also be manufactured.

The present invention is further illustrated by the following non-limiting examples.

### EXAMPLES

The formulations set forth in Table 1 were compounded on a BC21 Clextral twin-screw extruder at a screw speed of 200 rpm and a throughput of 7 kg/h. A flat temperature profile of around 270° C. used was used. Formulations were then injection molded and formed into test pieces for subsequent evaluation.

The combustion (flame retardancy) test was carried out using a 1.6 mm thick test piece. The test piece was measured using Standard UL-94 (Underwriters Laboratories Inc. of U.S.A.) in the vertical combustion.

The tensile modulus and tensile strength were measured by ISO Standard 527/1 using a test piece having a width of 4.0 mm. The painting quality was evaluated using the cross-hatch adhesion test method (ASTM 3359/ISO 2409). A lattice pattern was obtained by first making 6 parallel cuts with a cutting tool. There after, another six cuts overlapping the original cuts and at a 90 degree angle to the first cuts were then made. These cuts resulted in a cross cut area of 25 squares being obtained. All loose material was then removed with a brush. The lattice pattern was then covered with tape (Tesa 4651). The tape was removed quickly. The paint was then ready for evaluation. The crosscut area was evaluated and classified from GT0 to GT5 (excellent to poor). For the paint adhesion results reported in Table 2 the following polyester powder coats were used: Rohm and Haas 270-6000-2 (Bright green) and Beckers PD703023SG (yellow) with suitable crosslinker. Powder attraction was evaluated by weighing the parts.

Table 1 shows the formulations based on polyamide, glass fiber, carbon fiber reinforced that were compounded for our evaluation. Formulations A and B were similar except that formulation A contained a halogen-free flame retardant whereas formulation B did not include the flame retardant. Table 2 shows the property profiles of both compositions. Both formulations do show a sufficient conductivity suitable for electrostatic painting (powder coating) as confirmed by powder attraction to the part measurement. Nevertheless, it is seen that formulation A do showed an excellent powder coating capability as shown by the cross hatched test (GT0 performance) whereas the non-FR formulation B showed a very poor adhesion of the paint layer to the surface. This highlights the unexpected and synergistic adhesion promoter role of the flame retardant as it related to powder coatings. This effect is clearly visible as seen in FIG. 1. It is worthy of note that formulation A also showed excellent flammability performance (UL94 V0 at 1.6 mm), in addition its stiffness was higher as compared to formulation B, thereby making the composition suitable for metal replacement of structural parts.

TABLE 1
Formulations A, B

| RAW MATERIALS | Component | Formulation A | Formulation B |
|---|---|---|---|
| PA6 DOMAMID 24, Domo | Polyamide 6 | 21.3 | 29.8 |
| TECHNYL 24AE1, Rhodia | Polyamide 66 | 21.3 | 29.8 |
| Irganox 1098, Ciba | stabilizer | 0.15 | 0.15 |
| Irgafos 168, Ciba | stabilizer | 0.1 | 0.1 |
| EXOLIT OP 1312, CLARIANT | flame retardant | 17 | 0 |
| STEARATE ALUMINIUM | Release agent | 0.25 | 0.25 |
| GLASS FIBRE ECS 0.3T-249H, NEG | glass fiber | 30 | 30 |
| SIGRAFIL C25 Carbon Fiber | carbon fiber | 10 | 10 |

| | |
|---|---|
| 100 | 100 |

TABLE 2
Property Profile Formulation A, B

| PROPERTIES | Test | Units | Formulation A | Formulation B |
|---|---|---|---|---|
| PHYSICAL | | | | |
| Specific Weight | 1183 | g/cm3 | 1.48 | 1.41 |
| Shrinkage on 4 mm thickness | 2577 | % | 0.1 to 0.3 | 0.1 to 0.3 |
| MECHANICAL | | | | |
| Tensile strength | 527 | MPa | 181 | 223 |
| Tensile elongation at break | 527 | % | 2.4 | 2.6 |
| Flexural Strength | 178 | MPa | 252 | 289 |
| Flexural Modulus | 178 | MPa | 14100 | 12200 |
| Izod Notched, +23° C. | 180 | kJ/m² | 7.6 | 13 |
| Izod unnotched, +23° C. | 180 | kJ/m² | 55 | 77 |
| THERMAL | | | | |
| Melting Point | 3146 | ° C. | 234 and 261 | 225 and 265 |
| HDT, 1.8 MPa, Flat | 75 | ° C. | 219 | 221 |
| COMBUSTIBILITY | | | | |
| UL 94 on 1.6 mm thickness | UL 94 | Rating | V0 | HB |
| UL 94 on 3.2 mm thickness | UL 94 | Rating | V0 | HB |
| ELECTRICAL | | | | |
| Surface Resistivity | CEI 93 | Ohms | 5*10³ | 1.5 *10³ |
| PAINTABILITY | | | | |
| Cross Hatched test, 1 mm step | ASTM D3359 | rating | GT0 | GT5 |
| Cross Hatched test, 2 mm step | ASTM D3359 | rating | GT0 | GT5 |

While typical embodiments have been set forth for the purpose of illustration, the foregoing descriptions should not be deemed to be a limitation on the scope of the invention. Accordingly, various modifications, adaptations, and alternatives may occur to one skilled in the art without departing from the spirit and scope of the present invention.

What is claimed is:

1. A thermoplastic composition, comprising:
a) a thermoplastic resin;
b) a flame retardant including a metal salt of phosphinic acid, disphosphinic acid, or a combination thereof;
c) an electrically conductive filler; and
d) a reinforcing agent;
wherein a molded sample of the thermoplastic composition is capable of being electrostatically painted.

2. The thermoplastic composition of claim 1, wherein a molded sample of the thermoplastic composition that has been electrostatically painted is capable of achieving ASTM D3359 GT0 or GT1.

3. The thermoplastic composition of claim 1, wherein the thermoplastic resin is selected from a polyamide resin, an aromatic polyamide resin, a polyester, or a combination including at least one of the foregoing thermoplastic resins.

4. The thermoplastic composition of claim 1, wherein the flame retardant is selected from a phosphinate of the formula (I), a diphosphinate of the formula (II), or a mixture thereof 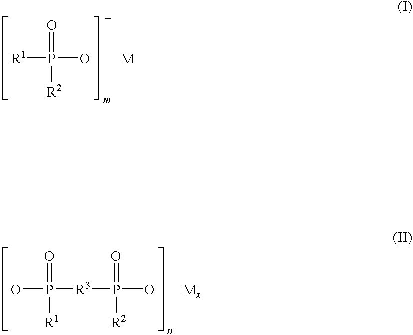
In which
R¹, R² is hydrogen, a linear or branched C1-C6 alkyl radical, and/or aryl radical;
R³ is a linear or branched C1-C10 alkylene, arylene, alkylarylene, or arylalkylene radical;
M is Calcium, Aluminium and/or Zinc
m is 1, 2 or 3;
n is 1 or 3
x is 1 or 2.

5. The thermoplastic composition of claim 1, wherein the flame retardant further comprises at least one nitrogen compound selected from condensation products of melamine and/or reaction products of condensation products of melamine with phosphoric acid, and/or mixtures thereof, melam, melem, melon, melamine, melamine cyanurate, melamine phosphate compounds, dimelamine phosphate, melamine pyrophosphate, melamine polyphosphate compounds, benzoguanamine compounds, terepthalic ester compounds of tris(hydroxyethyl)isocyanurate, allantoin compounds, glycoluril compounds, ammeline, ammelide, or combinations thereof.

6. The thermoplastic composition of claim 5, wherein the nitrogen compound comprises a compound of the formula (III) to (VIII) or combinations comprising at least one of the foregoing nitrogen compounds 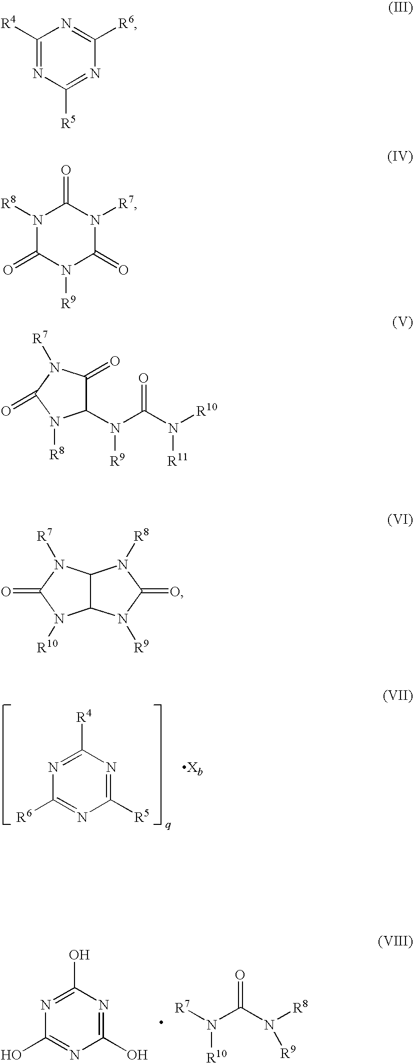
wherein R⁴, R⁵, and R⁶ are independently hydrogen, hydroxy, amino, or mono- or diC₁-C₈alkyl amino; or C₁-C₈alkyl, C₅-C₁₆cycloalkyl, -alkylcycloalkyl, wherein each may be substituted by a hydroxyl or a C₁-C₄hydroxyalkyl, C₂-C₈alkenyl, C₁-C₈alkoxy, -acyl, -acyloxy, C₆-C₁₂aryl, —OR¹² and —N(R¹²)R¹³ wherein R¹² and R¹³ are each independently hydrogen, C₁-C₈alkyl, C₅-C₁₆cycloalkyl, or -alkylcycloalkyl; or are N-alicyclic or N-aromatic, where N-alicyclic denotes cyclic nitrogen containing compounds; R⁷, R⁸, R⁹, R¹⁰ and R¹¹ are independently hydrogen, C₁-C₈alkyl, C₅-C₁₆cycloalkyl or -alkylcycloalkyl, each may be substituted by a hydroxyl or a C₁-C₄hydroxyalkyl, C₂-C₈alkenyl, C₁-C₈alkoxy, -acyl, -acyloxy, C₆-C₁₂aryl, and —O—R¹²; X is phosphoric acid, pyrophosphoric acid; q is 1, 2, 3, or 4; and b is 1, 2, 3, or 4.

7. The thermoplastic composition of claim 1, wherein the reinforcing agent is selected from glass fibers, calcinated clay, talc, wollastonite, barium sulfate, mica, barium titanate, silicates, zeolites, silicas, glass powders, glass-ceramic powders, magnesium hydroxide, hydrotalcites, magnesium carbonates, zinc oxide, zinc stannate, zinchydroxystannate, zinc phosphate, zinc borate, zinc sulfide, aluminium phosphate, red phosphorous, metal carborates of Be, Ca, Sr, Ba and Ra, or a combination including at least one of the foregoing reinforcing agents.

8. The thermoplastic composition of claim 1, wherein the electrically conductive filler is selected from carbon fiber, stainless steel fiber, carbon nanotubes, carbon fibrils, carbon black, or a combination including at least one of the foregoing electrically conductive fillers.

9. The thermoplastic composition of claim 1, further comprising from 0.5 to 20% by weight of one or more additives selected from anti-drip agents, heat stabilizers, process stabilizers, antioxidants, light stabilizers, plasticizers, antistatic agents, mold releasing agents, UV absorbers, lubricants, pigments, dyes, colorants, flow promoters or a combination of one or more of the foregoing additives.

10. The thermoplastic composition of claim 1, wherein a molded sample of the thermoplastic composition is capable of achieving UL94 V0 or V1 rating at a thickness of 1.5 mm (±10%).

11. The thermoplastic composition of claim 1, wherein the thermoplastic composition has a heat deformation temperature as measured by ISO 75 of 150° C. or greater.

12. The thermoplastic composition of claim 1, wherein the thermoplastic composition has a tensile modulus of 5000 MPa or greater.

13. The thermoplastic composition of claim 1, wherein the thermoplastic composition has a surface resistivity of 1 to 10⁴ Ohm/square meter.

14. An article of manufacture comprising the composition of claim 1.

15. The article of manufacture of claim 14, wherein the article is selected from automotive body panels, computer and business machine housings, hand held electronic device housings, electrical connectors, components of lighting fixtures, ornaments, home appliances, roofs, greenhouses, sun rooms, or swimming pool enclosures, safety door locking systems, heat systems and radiators, shutters, accessories for fences and posts.

16. A method of forming a thermoplastic composition comprising the steps of:
blending a thermoplastic resin; a flame retardant including a metal salt of phosphinic acid, disphosphinic acid, or a combination thereof; an electrically conductive filler; and a reinforcing agent; and
extruding the thermoplastic composition;
wherein a molded sample of the thermoplastic composition is capable of being electrostatically painted.

17. The method of claim 1, wherein a molded sample of the thermoplastic composition that has been electrostatically painted is capable of achieving ASTM D3359 GT0 or GT1.
